(19) United States
(12) Patent Application Publication
(10) Pub. No.: US 2006/0251306 A1
(43) Pub. Date: Nov. 9, 2006

(54) Apparatus and method of estimating motion of a target object from a plurality of images

(75) Inventor: Dong Kuk Shin, Seoul (KR)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Medison Co., Ltd., Hongchun-gun (KR)

(21) Appl. No.: 11/378,338

(22) Filed: Mar. 20, 2006

(30) Foreign Application Priority Data
Apr. 20, 2005 (KR) 10-2005-0032604

(51) Int. Cl. G06K 9/00

(52) U.S. Cl. 382/128

(57) ABSTRACT

The present invention relates to a method of estimating the motion of a target object from a plurality of images. The method includes: a) selecting consecutive first and second images from the plurality of images; b) decomposing the first and second images into a plurality of sub-images based on the frequency components of the first and second images by n levels, respectively, wherein n is a positive integer; c) selecting first and second sub-images of low frequency components from the plurality of sub-images; d) setting a feature pixel in the second sub-image; e) selecting an image block containing the feature pixel and a predetermined number of neighborhood pixels of the feature pixel; f) selecting a reference region from the first sub-image by comparing the image block with the first sub-image; g) calculating displacements between pixels of the reference region and pixels of the image block; h) storing the calculated displacements; i) performing 1-level composition for the decomposed images; j) repeatedly performing the steps c) to i) until the decomposed images become 1-level decomposed images; and k) estimating the motion of the target object based on the stored displacements.

### FIELD OF THE INVENTION

The present invention generally relates to an imaging system, and more particularly to an apparatus and method of estimating the motion of a target object from consecutively acquired images of an imaging system.

### BACKGROUND OF THE INVENTION

An imaging system is a system configured to display images of a target object and is widely used in various fields. An ultrasound diagnostic system is described below as an example of the imaging system.

The ultrasound diagnostic system projects ultrasound signal from the surface of a target object toward a desired portion within the target object and non-invasively obtains an ultrasound image of soft tissues or blood flow by using information obtained through ultrasound echo signals.

Compared to other medical imaging systems (e.g., X-ray diagnostic system, X-ray CT scanner, MRI and nuclear medicine diagnostic system), the ultrasound diagnostic system is advantageous since it is small in size and fairly inexpensive. Further, the ultrasound diagnostic system is capable of providing real-time display and is highly safe without dangerous side-effects such as exposure of X-rays, etc. Thus, it is extensively utilized for diagnosing the heart, abdomen and urinary organs, as well as being widely applied in the fields of obstetrics, gynecology, etc.

In particular, the ultrasound diagnostic system can form a panoramic ultrasound image based on ultrasound images, which are consecutively acquired by moving a probe along the surface of a human body. That is, the conventional ultrasound diagnostic system can form the panoramic ultrasound image by combining a currently acquired ultrasound image with previously acquired ultrasound images. For example, after consecutively acquiring ultrasound images of an object having an elongated shape (e.g., arm, leg, etc.) by moving the probe along a longitudinal direction of the object, the panoramic image can be formed by spatially combining the acquired ultrasound images. This makes it easy to observe the damaged portions of the object.

Generally, when displaying the panoramic ultrasound image or a moving ultrasound image, images estimating the motion of a target object are typically inserted between consecutive images in order to display the image that is close to a real image.

The conventional ultrasound diagnostic system estimates the motion of a target object by comparing all the pixels of consecutively inputted ultrasound images. Thus, a large amount of data needs to be processed, which typically requires a prolonged amount of time for such data to be processed.

Further, when the motion of a target object is estimated based on the consecutive ultrasound images, a speckle noise included in the ultrasound image may lessen the accuracy of such estimation.

### SUMMARY OF THE INVENTION

It is, therefore, an object of the present invention to provide an apparatus and method of decomposing consecutively inputted ultrasound images through wavelet transform to reduce the speckle noise and amount of data when estimating the motion of a target object based on the decomposed ultrasound images.

According to one aspect of the present invention, there is provided a method of estimating the motion of a target object from a plurality of images, including: a) selecting consecutive first and second images from the plurality of images; b) decomposing the first and second images into a plurality of sub-images based on the frequency components of the first and second images by n levels, respectively, wherein n is a positive integer; c) selecting first and second sub-images of low frequency components from the plurality of sub-images; d) setting a feature pixel in the second sub-image; e) selecting an image block containing the feature pixel and a predetermined number of neighborhood pixels of the feature pixel; f) selecting a reference region from the first sub-image by comparing the image block with the first sub-image; g) calculating displacements between pixels of the reference region and pixels of the image block; h) storing the calculated displacements; i) performing 1-level composition for the decomposed images; j) repeatedly performing the steps c) to i) until the decomposed images become 1-level decomposed images; and k) estimating the motion of the target object based on the stored displacements.

According to another aspect of the present invention, there is provided an apparatus of estimating the motion of a target object from a plurality of images, including: a first selecting unit for selecting consecutive first and second images from the plurality of images; a decomposing unit for decomposing the first and second images into a plurality of sub-images based on frequency components of first and second sub-images by n levels, wherein n is a positive integer; a second selecting unit for selecting the first and second sub-images of low frequency components from the plurality of sub-images; a setting unit for setting a feature pixel from pixels in the second sub-image; a third selecting unit for selecting an image block containing the feature pixel and a predetermined number of neighborhood pixels of the feature pixel; a fourth selecting unit for selecting a reference region from the first sub-image by comparing the image block with the first sub-image; a calculating unit for calculating displacements between pixels of the reference region and pixels of the image block; a storing unit for storing the calculated displacements; a composing unit for composing the decomposed images; and an estimation unit for estimating the motion of the target object based on the stored displacements.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram schematically illustrating an ultrasound diagnostic system constructed in accordance with the present invention;

FIGS. 2A and 2B are flowcharts showing a motion estimating method performed in an image processor constructed in accordance with the present invention;

FIG. 3 is a schematic diagram showing a procedure of 1-level wavelet transform;

FIG. 4 is a schematic diagram showing sub-images obtained through wavelet transform;

FIG. 5 is an exemplary diagram showing a procedure of 3-level wavelet transform;

FIGS. 6A and 6B are diagrams showing a horizontal gradient filter and a vertical gradient filter, respectively;

FIGS. 7A and 7B are schematic diagrams showing examples of applying a horizontal gradient filter and a vertical gradient filter to a sub-image; and

FIG. 8 is a schematic diagram showing an example of estimating the motion of a target object in accordance with the present invention.

### DETAILED DESCRIPTION OF THE PRESENT INVENTION

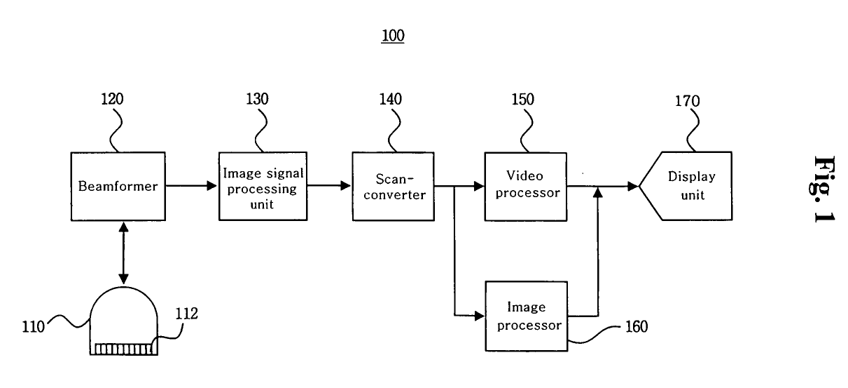

FIG. 1 is a block diagram schematically illustrating an ultrasound diagnostic system constructed in accordance with the present invention.

As shown in FIG. 1, an ultrasound diagnostic system 100 includes a probe 110, a beam-former 120, a signal processing unit 130, a scan converter 140, a video processor 150, an image processor 160 and a displaying unit 170. The ultrasound diagnostic system 100 may further include a storing unit such as a memory or the like. The video processor 150 and the image processor 160 may be provided as one processor.

The probe 110, which includes a 1-dimensional or 2-dimensional array transducer 112, is configured to sequentially transmit ultrasound signals to a target object as well as to sequentially receive echo signals from the target object. The ultrasound images of the target object may be consecutively acquired by scanning the target object with the probe 110. The consecutive ultrasound images may be a plurality of images displaying the motion of the target object. Also, the consecutive ultrasound images may be partial images of the target object. That is, an entire image of the target object may be observed through the partial images.

The beam-former 120 controls the delay of transmit signals, which are to be transmitted to the array transducer 112 of the probe 110 such that the ultrasound signals outputted from the array transducer 112 are focused on a focal point. It then focuses echo signals received by the array transducer 112 by considering the delay in which the echo signals reach each transducer.

The signal processing unit 130, which is a type of a digital signal processor, performs an envelope detection process for detecting the magnitude of the echo signal focused by the beam-former 120, thereby forming ultrasound image data.

The scan converter 140 performs the scan conversion for the ultrasound image data outputted from the signal processing unit 130.

The video processor 150 processes the scan-converted ultrasound image data outputted from the scan converter 140 to obtain a video format and transmit the processed ultrasound image data to the displaying unit 170.

The image processor 160 receives the ultrasound image data outputted from the scan converter 130 or the video processor 150.

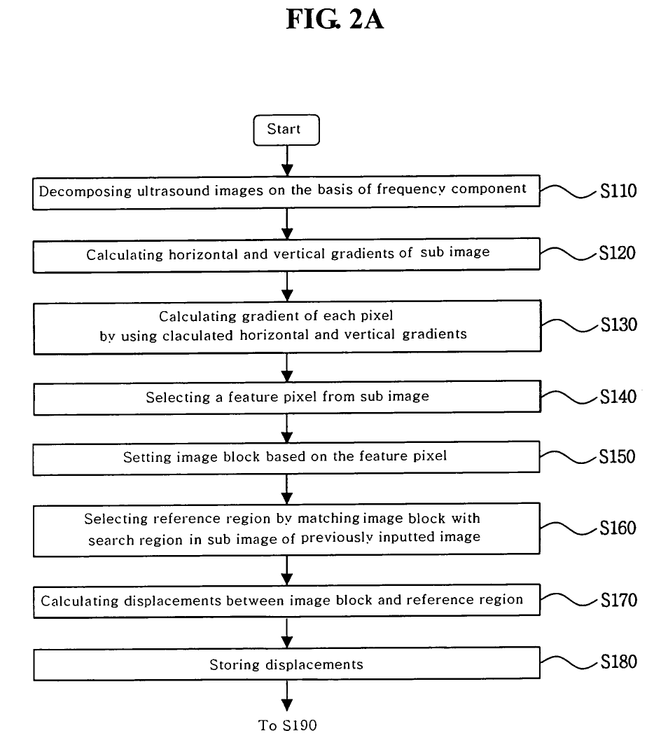

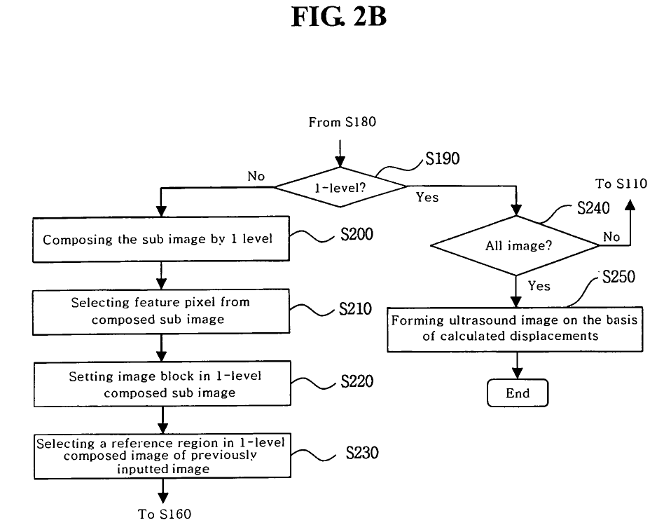

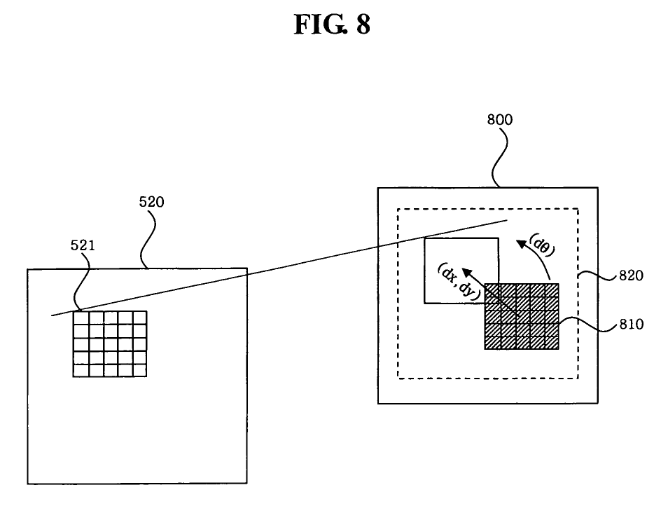

The operation of the image processor 160 is described below in view of FIGS. 2 to 8.

FIGS. 2A and 2B are flowcharts showing a motion estimating method, which is performed in the image processor 160 of the ultrasound diagnostic system 100.

Referring to FIGS. 2A and 2B, the image processor 160 decomposes the ultrasound images, which are consecutively inputted from the scan converter 140, based on the frequency components of a predetermined number at step S110. An image acquired through n-level decomposition is referred to as an n-level image. According to the preferred embodiment of the present invention, wavelet transform may be used to decompose the ultrasound image.

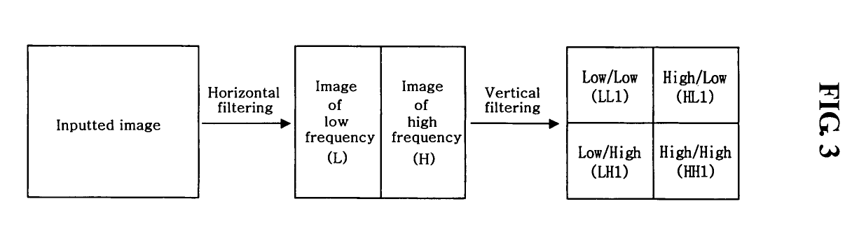

As illustrated in FIG. 3, a low pass filter and a high pass filter are applied to the inputted ultrasound image along a horizontal direction, thereby producing an image of a low band (L) and an image of a high band (H), respectively. The low pass filter and the high pass filter are then applied to L and H along a vertical direction, respectively, so that LL1, LH1, HL1 and HH1 sub-images can be obtained. The 1-level wavelet transform is carried out in accordance with the above process.

Thereafter, the low pass filter and the high pass filter are applied to the LL1 sub-image of a low frequency component along a horizontal direction. Then, the low pass filter and the high pass filter are applied along a vertical direction so that LL2, LH2, HL2 and HH2 sub-images can be obtained from the LL1 sub-image. As such, the 2-level wavelet transform can be completed. The 3-level wavelet transform is carried out for the LL2 sub-image of a low frequency component among the LL2, LH2, HL2 and HH2 sub-images.

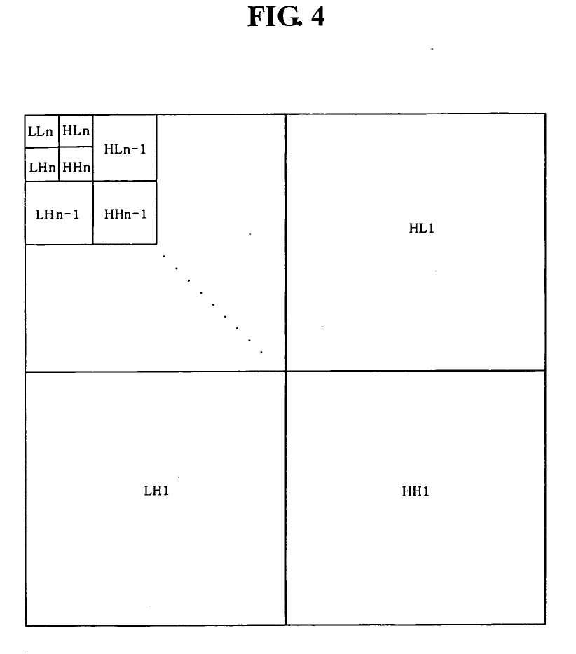

The image processor 160 continuously carries out the wavelet transform for the consecutively inputted ultrasound images of a predetermined number, thereby decomposing each ultrasound image into a plurality of sub-images to form and provide multi-resolution, as shown in FIG. 4. An LLn sub-image is the filtered original image of a low frequency component obtained through the wavelet transform. Further, HLn, LHn and HHn sub-images are images containing high frequency components of horizontal, vertical and diagonal orientations, respectively, for the LLn sub-image, wherein, n in LLn, HLn, LHn and HHn represents the level of wavelet transform.

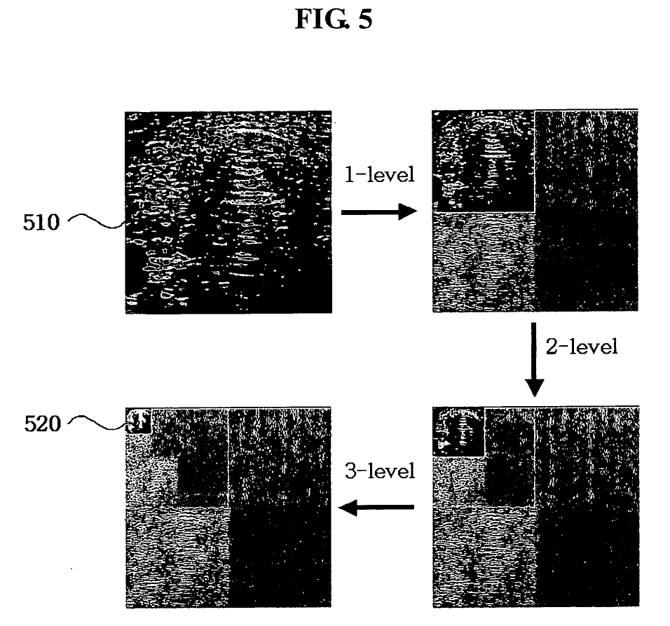

FIG. 5 illustrates the procedure of the 3-level wavelet transform for an inputted ultrasound image 510. An LL3 sub-image 520, which is shown in FIG. 5, is an image of a low frequency obtained through the 3-level wavelet transform.

The feature pixel is selected from the LL3 sub-image 520 obtained through the 3-level wavelet transform. The feature pixel is used as a reference pixel for motion estimation in accordance with the present invention. The feature pixel may be selected as a pixel having the highest gray level, luminescence or gradient among various pixels consisting the LL3 sub-image 520.

The reason for selecting the feature pixel from the LL3 sub-image 520 is that the LL3 sub-image 520 is an image, which can best remove the speckle noise among the HL3, LH3 and HH3 sub-images.

The method of selecting the feature pixel from the LL3 sub-image 520 is discussed below.

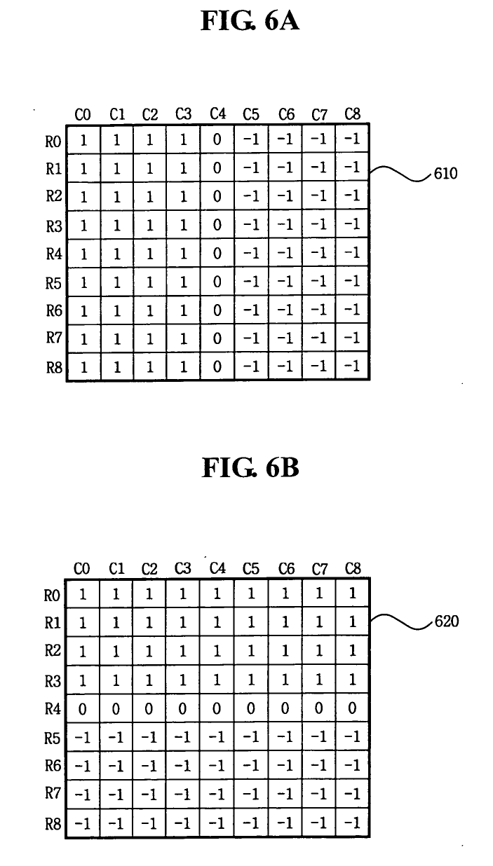

A horizontal gradient filter 610 and a vertical gradient filter 620 shown in FIGS. 6A and 6B, respectively, are applied to each pixel comprising the LL3 sub-image 510. This is so that the horizontal and vertical gradients Sx and Sy of each pixel can be calculated at step S120.

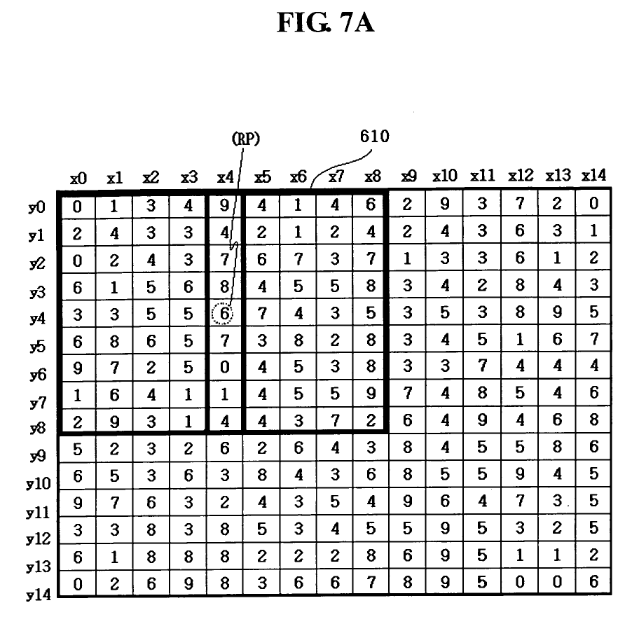

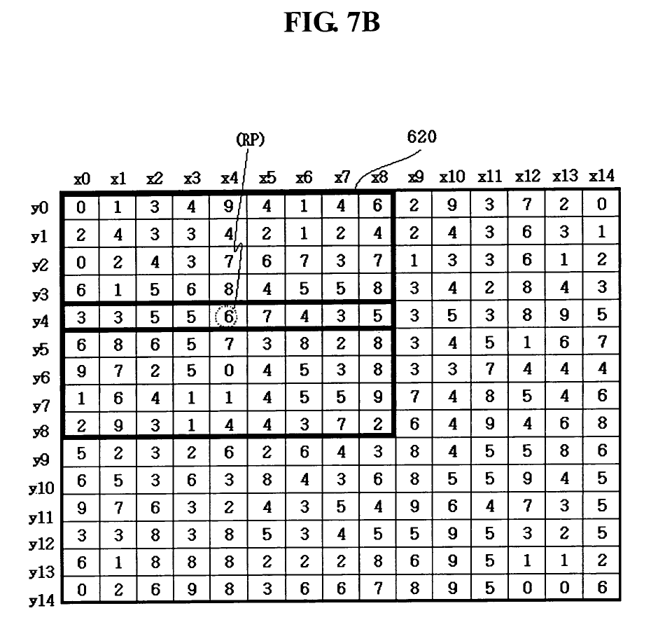

To calculate the horizontal gradient Sx of a target pixel RP included in the LL3 sub-image 510, which has a gray level distribution pattern as shown in FIGS. 7A and 7B, the horizontal gradient filter 610 is applied to the LL3 sub-image 510. This is so that a center pixel (R4, C4) of the horizontal gradient filter 610 is positioned to the target pixel RP of the LL3 sub-image 520, as shown in FIG. 7A. Then, each pixel value of the horizontal gradient filter 610 is multiplied by each gray level of the LL3 sub-image 520. As such, the filtered values for the pixels of the LL3 sub-image 520 can be obtained.

Subsequently, the filtered values existing in left columns of center column x4 are summed together to thereby obtain a first adding value. Then the filtered values existing in right columns of center column x4 are also summed together, thereby obtaining a second adding value. That is, the first adding value is 138 (=0+2+0+6 +3+6+9+1+2+1+4+2+1+3+8+7+6+9+3+3+4+5+5+6+2+4+3+4+3+3+6+5+5+5+1+10) and the second adding value is −168 (=−4+(−2) +(−6)+(−4)+(−7)+(−3)+(−4)+(−4)+(−4)+(−1)+(−1)+(−7)+(−5)+(−4)+(−8)+(−5)+(−5)+(−3)+(−4)+(−2)+(−3)+(−5)+(−3)+(−2)+(−3)+(−5)+(−7)+(−6)+(−4)+(−7)+(−8)+(−5)+(−8)+(−8)+(−9)+(−2)).

The image processor 160 calculates the horizontal gradient Sx of the target pixel RP by summing the first adding value and the second adding value. The gradient of the target pixel RP becomes −30 (=138+(−168)). The above process, which calculates the gradient of the target pixel RP is repeatedly carried out by changing the target pixel. The method of calculating a vertical gradient Sy of each pixel is carried out in a similar manner as the method of calculating the horizontal gradient Sx. In order to calculate the vertical gradient Sy, the vertical gradient filter 620 is applied to the LL3 sub-image 520 instead of the horizontal gradient filter 610, as shown in FIG. 7B.

After obtaining the filtered value by applying the vertical gradient filter 620 to the LL3 sub-image 520, the filtered values corresponding to coordinates (xi, yj) positioned at the upper side of center row y4 are summed together, wherein “i” is a positive integer ranging from 0 to 8 and “j” is a positive integer ranging from 0 to 3, thereby obtaining a third adding value. Also, the filtered values corresponding to coordinates (xm, yn) positioned at the lower side of center row y4 are also summed together, wherein “m” is a positive integer ranging from 0 to 8 and “n” is a positive integer ranging from 5 to 8, thereby obtaining a fourth adding value. Thereafter, the vertical gradient Sy of the target pixel RP is calculated by summing the third adding value and the fourth adding value. The above process, which calculates the vertical gradient of the target pixel RP, is repeatedly carried out by changing the target pixel.

After calculating the horizontal and vertical gradients Sx and Sy of each pixel as described above, the gradient S of each pixel is calculated by applying the calculated horizontal and vertical gradients Sx and Sy to the following equation:
S=\sqrt{Sₓ²+S_{y}²} (1)

The calculated gradients of the pixels are compared with each other and the pixel having the maximum gradient is selected as the feature pixel at step S140. If the feature pixel is selected, an image block 521 including the feature pixel and a predetermined number of pixels neighboring the feature pixel in the LL3 sub-image 520 is set at step S150.

After setting the image block 521, a reference region 810 is selected within a search region 820 of a LL3 sub-image 800, which is obtained from a immediately previous inputted ultrasound image through the 3-level wavelet transform, by using the image block 521 at step S160. The selection of the reference region 810 is determined based on a minimum sum absolute difference (SAD) by comparing the image block 521 with search the region 820.

The search region 820 is determined by removing the edge regions from the LL3 sub-image 800 in accordance with the preferred embodiment of the present invention. Also, the entire region of the LL3 sub-image 800 may be the search region 820 according to a process condition. Even if a region having the minimum SAD is searched in the edge region, the reference region should be selected from the region except the edge region.

The region having the minimum SAD may be searched based on the following equation:

$${\sum }_{y = 0}^{S} {\sum }_{x = 0}^{S} \vert {Pn}_{( X - x - dx , Y - y - dy )} - {Po}_{( X - y , Y - y )} \vert \qquad ( 2 )$$

Wherein Pn is a gray level of each pixel consisting the image block 521, Po is a gray level of each pixel consisting the previous LL3 sub-image 800, X and Y represent the coordinates of the feature pixel selected from current LL3 sub-image 520, and dx and dy are the distance displacements of coordinates between each pixel of the image block 521 and each pixel of the reference region 810.

The reference region 810, which is the region most corresponding to the image block 521, can be estimated as a region in which an image corresponding to the image block 521 is previously located. That is, it can be estimated that the image block 521 is moved from the reference region 810 in the previous LL3 sub-image 800. Accordingly, after calculating the displacements dx3 and dy3 of coordinates between each pixel of the reference region 810 and each pixel of the image block 520, the rotation displacement dq3 of coordinates, in which SAD becomes minimal, is calculated at step S170. In displacements dx3, dy3 and dq3, the number “3” means that the displacement is calculated for the 3-level wavelet transformed ultrasound image. Thereafter, it is determined whether the current image corresponds to a 1-level wavelet transformed image at step S190.

If it is determined that the current image does not correspond to the 1-level wavelet transformed image at step S190, 1-level inverse wavelet transform is carried out at step S200. The image processor 160 determines the feature pixel from the sub-image of a low frequency component obtained through the 1-level inverse wavelet transform at step S210 and selects an image block based on the determined feature pixel at step S220. A region having the minimum SAD is selected as a reference region from the previous LL sub-image obtained through the 1-level inverse wavelet transform at step S230 and then the process proceeds to step S170. That is, if the reference region is determined at step S230, displacements dx2, dy2 and dq2 are calculated by comparing the coordinates between each pixel of the reference region and each pixel of the image block at step S170. The calculated displacements dx2, dy2 and dq2 are stored at step S180. As described above, the number “2” in the displacements dx2, dy2 and dq2 means that the displacements are calculated for a 2-level wavelet transformed ultrasound image. Also, the displacements obtained through twice 1-level inverse wavelet transform can be represented as dx1, dy1 and dq1.

When the inverse wavelet transform is carried out, the size of the sub-image becomes enlarged. Therefore, the displacements are calculated in consideration that the sizes of the image block and the search region become enlarged as the inverse wavelet transform is carried out.

Meanwhile, if it is determined that the sub-images correspond to a 1-level wavelet transformed image at step S190, then it is determined whether the above process (steps S110-S180) is carried out for all the ultrasound images in the image processor 160 at step S240. If it is determined that the above process is not carried out for all of the ultrasound images at step S240, then the process returns to step S100 and then the process mentioned above is carried out. On the other hand, if it is determined that the process is completed for the all of the ultrasound images at step S240, the image processor 160 estimates the motion of the target object based on the displacements dx, dy and dq and then forms an ultrasound moving image at step S250. For example, the motion of the target object in an x direction can be estimated through selecting the smallest one among displacements dx3, dx2 and dx1 or averaging the displacements dx3, dx2 and dx1. The ultrasound moving image may be a typical moving image or a panoramic image.

As discussed above, since the consecutively inputted ultrasound images are wavelet transformed, the speckle noise can be reduced. Thus, the motion estimation of the target object in the ultrasound images is accurately carried out in accordance with the present invention. Also, since the decomposed image is used to estimate the motion of the target object, the amount of data to be processed for the motion estimation can be reduced. Therefore, the process of estimating the motion of the target object can be carried out more quickly.

While the present invention has been described and illustrated with respect to a preferred embodiment of the invention, it will be apparent to those skilled in the art that variations and modifications are possible without deviating from the broad principles and teachings of the present invention which should be limited solely by the scope of the claims appended hereto.

What is claimed is:

1. A method of estimating a motion of a target object from a plurality of images, comprising:
a) selecting consecutive first and second images from the plurality of images;
b) decomposing the first and second images into a plurality of sub-images based on the frequency components of the first and second images by n levels, respectively, wherein n is a positive integer;
c) selecting first and second sub-images of low frequency components from the plurality of sub-images;
d) setting a feature pixel in the second sub-image;
e) selecting an image block containing the feature pixel and a predetermined number of neighborhood pixels of the feature pixel;
f) selecting a reference region from the first sub-image by comparing the image block with the first sub-image;
g) calculating displacements between pixels of the reference region and pixels of the image block;
h) storing the calculated displacements;
i) performing 1-level composition for the decomposed images;
j) repeatedly performing the steps c) to i) until the decomposed images become 1-level decomposed images; and
k) estimating the motion of the target object based on the stored displacements.

2. The method as recited in claim 1, wherein the plurality of consecutive images are ultrasound images.

3. The method as recited in claim 1, wherein the steps b) and i) are carried out with wavelet transform and inverse wavelet transform, respectively.

4. The method as recited in claim 1, wherein the step d) comprises the steps of:
d1) calculating horizontal and vertical gradients of each pixel comprising the second sub-image;
d2) calculating gradient of each pixel of the second sub-image; and
d3) comparing gradients of pixels with each other and selecting a pixel having maximal gradient as the feature pixel.

5. The method as recited in claim 4, wherein the horizontal and vertical gradients are calculated by using gray level of each pixel.

6. The method as recited in claim 4, wherein the horizontal and vertical gradients are calculated by using luminescence of each pixel.

7. The method as recited in claim 4, wherein the reference region has a minimum sum absolute difference with the image block.

8. The method as recited in claim 1, wherein the step g) comprises the steps of:
g1) calculating distance displacements between each pixel of the image block and each pixel of the reference region; and
g2) calculating rotation displacement by rotating the image block for the reference region.

9. An apparatus for estimating a motion of a target object from a plurality of images, comprising:
a first selecting unit for selecting consecutive first and second images from the plurality of images;
a decomposing unit for decomposing the first and second images into a plurality of sub-images based on the frequency components of the first and second images by n levels, respectively, wherein n is a positive integer;
a second selecting unit for selecting first and second sub-images of low frequency components from the plurality of sub-images;
a setting unit for setting a feature pixel from pixels in the second sub-image;
a third selecting unit for selecting an image block containing the feature pixel and a predetermined number of neighborhood pixels of the feature pixel;
a fourth selecting unit for selecting a reference region from the first sub-image by comparing the image block with the first sub-image;
a calculating unit for calculating displacements between pixels of the reference region and pixels of the image block;
a storing unit for storing the calculated displacements;
a composing unit for composing the decomposed images; and
an estimating unit for estimating the motion of the target object based on the stored displacements.

10. The apparatus as recited in claim 9, wherein the plurality of consecutive images are ultrasound images.

11. The apparatus as recited in claim 9, wherein the decomposing unit and the composing unit are operated by using wavelet transform and inverse wavelet transform, respectively.

12. The apparatus as recited in claim 9, wherein the setting unit includes:
a first calculating unit for calculating horizontal and vertical gradients of each pixel comprising the second sub-image;
a second calculating unit for calculating gradient of each pixel of the second sub-image by using the calculated vertical and horizontal gradients; and
a comparing unit for comparing gradients of pixels with each other and selecting a pixel having maximal gradient as the feature pixel.

13. The apparatus as recited in claim 12, wherein the horizontal and vertical gradients are calculated by using gray level of each pixel.

14. The apparatus as recited in claim 12, wherein the horizontal and vertical gradients are calculated by using luminescence of each pixel.

15. The apparatus as recited in claim 9, wherein the reference region has a minimum sum absolute difference with the image block.

16. The apparatus as recited in claim 9, wherein the calculating unit includes:
a first calculating unit for calculating distance displacements of coordinates between each pixel of the image block and each pixel of the reference region; and
a second calculating unit for calculating rotation displacement of coordinates by rotating the image block for the reference region.
